(19) United States
(12) Patent Application Publication
(10) Pub. No.: US 2002/0198958 A1
(43) Pub. Date: Dec. 26, 2002

(54) System and method for the delivery of information

(76) Inventors: Richard H. Frenkiel, Manalapan, NJ (US); Narayan B. Mandayam, Piscataway, NJ (US); Christopher Rose, New Rochelle, NY (US); Ivan Seskar, Franklin Park, NJ (US); Roy D. Yates, East Brunswick, NJ (US); James G. Evans, Forked River, NJ (US)

Correspondence Address: MORRISON & FOERSTER LLP, 2000 PENNSYLVANIA AVE, NW, SUITE 5500, WASHINGTON, DC, 20006-1888, US

(21) Appl. No.: 10/016,141

(22) Filed: Dec. 17, 2001

Related U.S. Application Data
(60) Provisional application No. 60/256,469, filed on Dec. 20, 2000.
(60) Provisional application No. 60/259,159, filed on Jan. 3, 2001.
(60) Provisional application No. 60/278,273, filed on Mar. 23, 2001.

(51) Int. Cl. G06F 15/16

(52) U.S. Cl. 709/217

(57) ABSTRACT

A system and method for the delivery of information. A network permits the transfer of small to large data files through a variety of delivery methods, such as physical or electronic means. The information may include different types of media content, which may be selected and retrieved by a user. The user can select the location and time for delivery of the information, which is retrievable and downloadable to a personal device. This allows users to acquire the information in a relatively short period of time and at neighboring locations.

### CLAIM FOR PRIORITY

This application claims priority to Provisional Application Nos. 60/256,469 filed Dec. 20, 2000; 60/259,159 filed Jan. 3, 2001; and 60/278,273 filed Mar. 23, 2001.

### TECHNICAL FIELD OF THE INVENTION

The present invention relates to a system and network for the delivery of information, and in particular, for the delivery of large information files, such as DVD-quality movies, to a local transfer station to be downloaded by a user to a portable terminal device.

### BACKGROUND OF THE INVENTION

The delivery of information over a network has increasingly become a staple in our daily lives. With the evolution of networks such as the Internet and wireless telephony, communication across vast distances has become possible with the stroke of a key and the touch of a button. Information filled with rich media has become easier to obtain and has therefore added a richer viewing experience for the user. Families are able to send the latest photo album across continents, and business men and women alike are able to correspond at the touch of a “click.” However, today's networks continue to struggle with the transfer of large data files (e.g. music or movies including 4-5 gigabytes of data) within an adequate time frame or at a reasonable expense. To date, delivery of this size file has proved to be impractical, especially if attempting to do so over a wireless network or in a timely fashion. The fastest wireline or satellite connections to the home are still inadequate or too expensive for large video files, and the Internet itself is dwarfed by the potential demand. If, for example, a large number of households begin to download movies (e.g. DVD-quality) over the Internet, it will increase traffic over the Internet by orders of magnitude. Hence, while broadcast, cable and satellite systems offer a wide range of mass-media entertainment to the home at attractive rates, these networks are not adequate to the provision of “personal choice” in such media. In wireless networks, the transfer of large data files is even more difficult. At present cellular bit rates and costs, the download of a DVD-quality movie would take several hundred hours and cost several thousand dollars. Third-generation cellular systems will provide today's Internet services for people on the move, but a movie download would still take 5-50 hours without much cost reduction.

Given the present day restraint on delivery of large data files over a network, people are still inclined to rent movies or order them using an on-demand system, such as pay-per-view. Of course, video tapes and DVDs must be picked up and then returned to the store, often times resulting in a late fee for being returned past due. In addition, the number of rentals for each movie are limited by the number of copies set aside in a given store. Customers often find that the selection of movies is less than desired, as the most popular movies are typically rented. Often times, these stores normally do not provide alternatives to movies, such as evening news, re-runs of programs, or customized information, since it is economically unfeasible to provide inventories of such information. On-demand systems, on the other hand, provide customers an alternative to having to go to the store to rent a movie. Rather, the customer can select a movie from their home, without having to worry about returning it. However, there are several drawbacks to on-demand video. For example, the selection of movies is often limited, and the customer cannot typically pause the movie during playback.

### SUMMARY OF THE INVENTION

In one embodiment of the invention, there is a method for distributing data over a network. The method includes, for example, providing local transfer stations configured to receive the data from a remote storage device and to output the data to a terminal device comprising a recordable medium for storing the data and information for data authorization and transferring the data to at least one of the local transfer stations for download of the data to the terminal device.

In another aspect of the invention, the data is stored in an encrypted format based at least in part on the information for the data authorization.

In another aspect of the invention, the transferring occurs via a communicative coupling between the remote storage device and the local transfer stations.

In yet another aspect of the invention, the communicative coupling comprises at least one of a network connection, a wireless link, a terrestrial broadcast, a satellite broadcast or fiber optic link.

In another aspect of the invention, the transferring provides the storage device to at least one of the local transfer stations according to the request.

In another aspect of the invention, the request specifies a particular time before which the transferring is to be performed.

In still another aspect of the invention, the method includes receiving a plurality of requests for delivery of the data to selected local transfer stations, wherein the transferring includes scheduling the delivery to the selected transfer stations.

In another aspect of the invention, the method includes transferring the data from a remote site via electronic connection to one or more of the local transfer stations.

In another aspect of the invention, the method includes operating at least one of the local transfer stations to download a requested portion of the data to the receiving device.

In yet another aspect of the invention, the download for the local transfer station to the device is wireless.

In another aspect of the invention, the method includes outputting the data in response to a signal from the receiving device.

In another aspect of the invention, the request selects the data and at least one of said local transfer stations.

In still another aspect of the invention, the method includes providing a service center coupled to at least one of the local transfer stations by communication lines.

In another aspect of the invention, at least one of the local transfer stations are located at commuter transit stations and wherein the data includes movies.

In another embodiment of the invention, there is a method of accessing data for download to a receiving device. The method includes, for example, providing a plurality of service centers to process requested data from users on a network, providing a plurality of local transfer stations within a geographic area and accessible by the network, the local transfer stations configured with links to link with the receiving device in order to select and download the requested data over one of the links, and loading the plurality of transfer stations with subsets of the data in the geographic area. In another embodiment of the invention, there is a system for data distribution, the data stored on a recordable medium. The system includes, for example, local transfer stations configured to receive the data from the recordable medium and to output the data, a service center to process requests for the data at at least one of the local transfer stations, the processing including scheduling the delivery of the requested data to the selected transfer station, and transport devices for physically transporting the recordable medium storing the requested data to the selected transfer station.

In another aspect of the invention, the local transfer stations output the data to a receiving device.

In another aspect of the invention, the system includes a communications link between at least one of the local transfer stations and the service center, wherein the service center receives the requests from the at least one local transfer station via the link.

In yet another aspect of the invention, the system includes at least another service center for servicing the local transfer stations and communication links between the service center and the at least another service center.

In another embodiment of the invention, there is a method for distribution of data over a network. The method includes, for example, transporting data from a service center to a local transfer station, wherein the data is requested by a user having access to the network, storing the requested data at the local transfer station for retrieval by the user, and transferring the requested data to a portable receiving device, wherein the data is encrypted and the receiving device is configured to decrypt the requested data.

In still another embodiment of the invention, there is a method of transferring data over a hybrid network. The hybrid network includes a plurality of networks, each network configured for physical and/or electronic transfer of the data. The method includes, for example, physically transporting data from a first network to a second network, storing the transported data to a local transfer station for distribution based on a user request, and transferring the requested data to a portable receiving device, wherein the data stored on the local transfer station is encrypted and the portable receiving device is configured to decrypt the data.

### BRIEF DESCRIPTION OF THE DRAWINGS

FIG. 1 illustrates an exemplary embodiment of a global network in accordance with the present invention.

FIG. 2 illustrates an exemplary embodiment of a local transfer station used in accordance with the present invention.

FIG. 3 illustrates another exemplary embodiment of a local transfer station used in accordance with the present invention.

FIG. 4 illustrates an exemplary embodiment of a terminal device.

FIG. 5 illustrates an exemplary service center.

FIG. 6 illustrates an exemplary flow of operation according to the present invention.

FIG. 7 illustrates an exemplary flow of operation according to the present invention.

FIG. 8 illustrates an exemplary flow of operation according to the present invention.

### DETAILED DESCRIPTION OF THE PREFERRED EMBODIMENTS

The present invention is directed to a network for the delivery of data and information files. The network includes, among other components, local transfer stations or kiosks designed to deliver a rich menu of small-to-large files to terminal devices, at a very low cost. The files and data can include for example movies, network television programming, music, books in audio and text formats, magazines and newspapers, local geographic information, computer software and personal information. The terminal devices, which are portable in the preferred embodiment, can store and transport this information, and have the ability to display it on a variety of portable and/or home (or office) based devices, such as a television, personal computers, music players, VCRs, laptops and palmtops. This network of information provides a unique way to distribute entertainment for use by consumers, in an effective and efficient manner previously unavailable.

A large selection of media content (i.e. data) of different types can be ordered for physical delivery, or optionally, for electronic transfer, to a selected location at a selected time, for download to a user's device. Physical delivery affords high enough “bandwidth” to meet the needs of users for video and other large files, while electronic transfer provides for quick transfer of smaller information files, such as news, emails, etc. The network also affords users in respective geographic areas easy and quick access to a versatile menu of media content that is stored in the transfer device and is immediately selectable and downloadable to the user's device. Additionally, users may transfer (i.e. upload) files over the network for storage and subsequent retrieval at the time and place of their choosing. Numerous other aspects and features of the invention are presented in the following description.

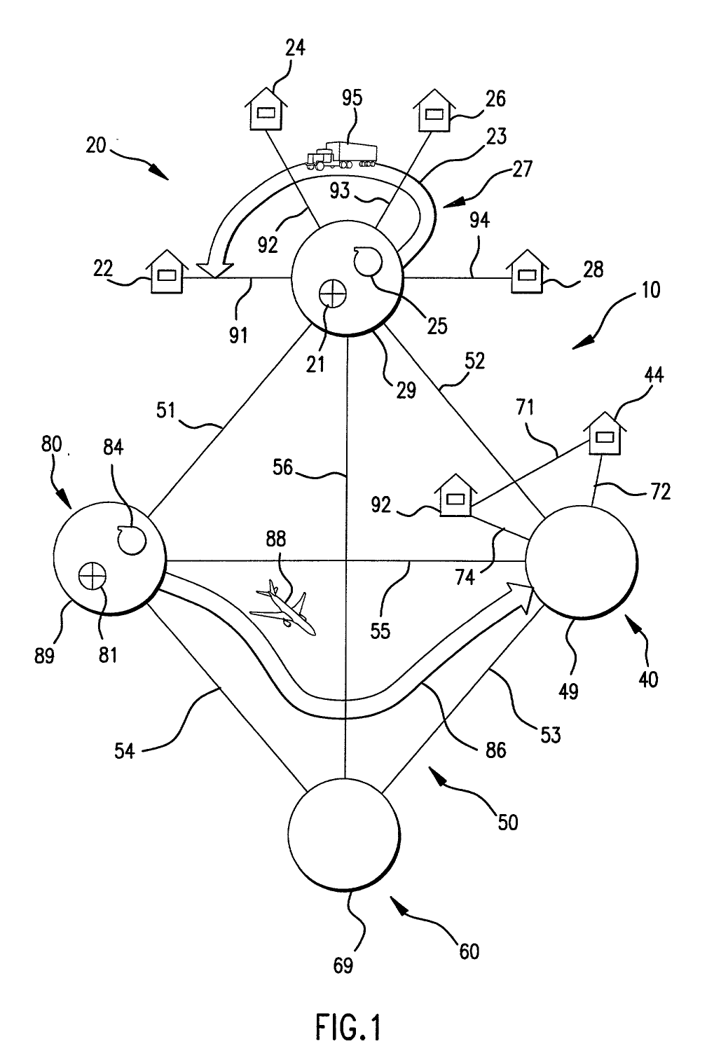

An exemplary network of the present invention is illustrated in FIG. 1, and comprises four main elements: (1) a local transfer station (i.e. a kiosk), (2) terminal devices (e.g. personal data pack), (3) service centers (national and local), and (4) a hybrid network.

The kiosks 22, 24, 26 and 28 are public access points that are capable of storing a large amount of data, including movies, music, books (text and audio), as well as a variety of other information, such as current and archival television programming, newspapers, magazines, email, voicemail, advertising, etc. The storage capacity can be upgraded to accommodate space requirements, and also may provide descriptive information associated with the stored content, such as book reviews, samples of the music and a preview of a movie. As noted above, the kiosks 22, 24, 26 and 28 can be placed at strategically located positions, such as shopping malls and gas stations, for the convenience of users.

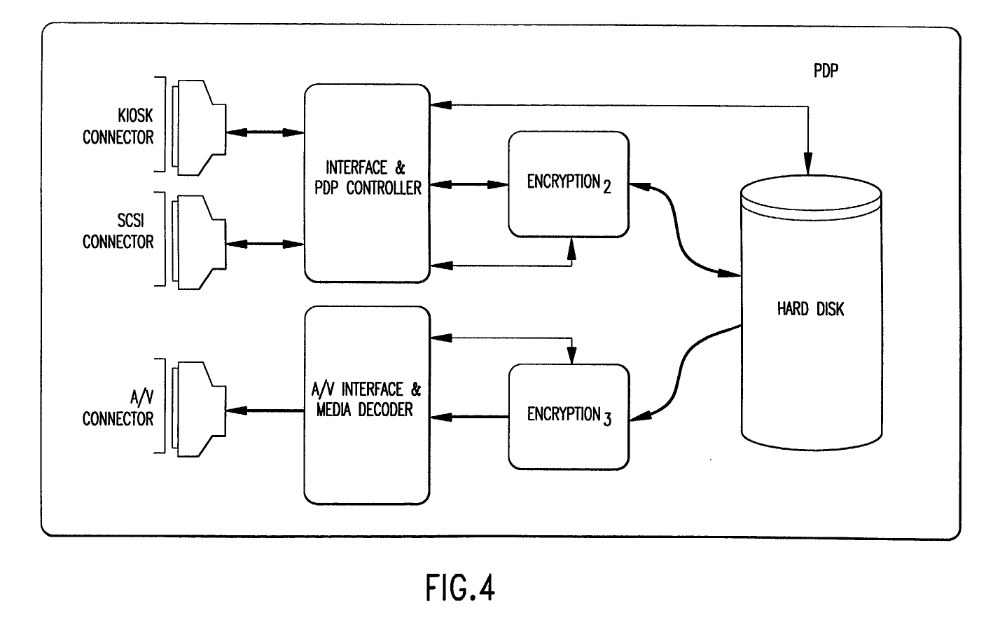

In the preferred embodiment, the kiosks 22, 24, 26 and 28 will be connected to the network 10 via a local or regional service center 29, 49, 69 and 89. This connection may be in the form of a low-speed telephone line or cellular connection, or a higher speed cable, DSL, or fiberoptic connection. Low-speed connections may prove ideal for high risk or confidential areas, such as billing and special orders, while a higher speed connection may be best suited for time-critical information, such as news or financial information, to be downloaded to the kiosk 22, 24, 26 and 28 from the service centers 29, 49, 69 and 89. The kiosks 22, 24, 26, and 28 could also provide an Internet connection to users for access to a variety of additional information. In one embodiment, the kiosks 22, 24, 26 and 28 act as stand-alone servers, with no connection to a larger network. In this regard, information in the kiosks 22, 24, 26 and 28 would be provided by physical delivery of information. The kiosks 22, 24, 26 and 28 will also provide additional storage space beyond that used for storing retrievable information, and a port for uploading information to the additional storage in the kiosk 22, 24, 26 and 28. That is, a user could attach, for example, his or her terminal device, such as a personal data pack or PDP (see, e.g., FIG. 4), laptop or palm device to the kiosk 22, 24, 26 and 28 and upload information for storage. This information could include special requests, messages for a service center 29, 49, 69 and 89 (e.g. email or voicemail messages for personnel staffed at the service centers), or any other type of information. Each kiosk 22, 24, 26 and 28 will provide several methods of download, as previously alluded to and described below.

In the preferred, and fastest, form of downloading, PDPs can “plug” into the kiosk 22, 24, 26 and 28 using, for example, a plug-in socket. Plug-ins include multiple ports to allow multiple users to download information in parallel. In an alternative embodiment, broadband radio is used for the transfer (i.e. download, retrieval or upload) of information. This embodiment would typically require more time for the transfer of information, assuming the same size file, but would have the advantage of allowing download and retrieval of information at relatively short range (e.g. 10-30 yards) from the kiosk 22, 24, 26 and 28 without a wired connection. Of course, download and upload will depend on the available bandwidth, but would provide the ability for users to access the kiosks 22, 24, 26 and 28 from a distance, for example, from an automobile parked within range of the kiosk 22, 24, 26 and 28. An uplink channel provides communications from the terminal device (see, e.g., FIG. 4) to the kiosk 22, 24, 26 and 28, enabling the user to transfer or upload data to the kiosk 22, 24, 26 and 28. Other embodiments include an infrared or wireless interface, such as Bluetooth and 802.11. These embodiments would likely be used for smaller files, such as the transfer of email, books, newspaper, etc. Kiosks may also be portable. For example, a vehicle could transport kiosks in a manner such that the kiosk comes to the user, as opposed to the user going to the kiosk.

The terminal devices will provide users with a device to download and—retrieve data from the kiosks 22, 24, 26 and 28 for storage and listening or viewing. The terminal device, e.g., PDP in FIG. 4, will also allow the user to upload information to the kiosk 22, 24, 26 and 28, as described above. The terminal devices or PDPs will be available in a variety of embodiments, such as a simple hard drive to a more complex processor driven storage device, or using hologram storage technology or any other form of storage. Each terminal device or PDP may have the capability to encrypt and decrypt content and play it through another device, such as a VCR, DVD player or television. Power to the terminal device or PDP may be provided by the interfacing device or using batteries. A display can be added to the terminal device or PDP such that information stored on it can be viewed, and an input device on the terminal device or PDP would allow a user to select content on the terminal device or PDP. Another embodiment of the terminal device or PDP provides both a plug-in and a radio interface. This permits a user to perform multiple tasks, such as download menus, previews and critical reviews, while concurrently downloading or retrieving data to the terminal device or PDP. Other embodiments of the terminal device or PDP can also be provided, such as replacing the plug-in interface with an infrared interface, or radio interface to enable, for example, laptops and palmtops to communicate with the kiosk 22, 24, 26 and 28.

The regional or local service centers 29, 49, 69 and 89 will provide highly automated centers to store a very large menu of content, and have access to additional content (e.g. content in addition to that stored at local kiosks or at an individual service center) from a variety of sources. That is, the service centers 29, 49, 69 and 89 are the repository for the information files available for distribution over the network 10, and can gather additional information from different sources, including from other service centers 29, 49, 69, 89 and the network 10. The service centers 29, 49, 69 and 89 will receive orders from customers, schedule files for distribution to the kiosks 22, 24, 26 and 28, and control the download of the files into the network which delivers them to the kiosks 22, 24, 26 and 28. Of course, a national service center, one which services the entire network 10, could optionally replace, or act together with, the service centers 29, 49, 69 and 89. The service centers 29, 49, 69 and 89 will operate using, for example, application software and/or service personnel. The software and/or service personnel will operate to accept orders, add orders to other information for distribution, account for the capability of the network 10, schedule deliveries, confirm orders to the customers, etc. Orders can be placed with the service centers 29, 49, 69 and 80 via, for example, email, the Internet, over the telephone or through the kiosks 22, 24, 26 and 28.

Although the service centers 29, 49, 69 and 89 provide a preferred embodiment of the invention, an alternative embodiment of the network 10 provides for the service centers 29, 49, 69 and 89 to be bypassed (entirely or during certain situations). Under this scenario, a direct connection is established with the kiosks 22, 24, 26 and 28, such that information is directly transferred thereto. For example, time-sensitive information, such as stock quotes, can be delivered directly to the kiosks 22, 24, 26 and 28 from another source. The connection to the kiosk 22, 24, 26 and 28 would still be under the control of the network 10, and as such downloads can be scheduled and monitored as necessary. Where information scheduled for delivery directly to the kiosks 22, 24, 26 and 28 cannot be properly handled, connections to include the service centers 29, 49, 69 and 89 can be reinstated.

A primary concern associated with implementation of a network to transfer large data files is the time and cost associated with such transfer. The hybrid network (for example, local hybrid network 27 or network 10, as illustrated in FIG. 1) provides the infrastructure to utilize both wireline and wireless or physical transportation modes. That is, the network 10 is formed from a variety of different networks, which are interconnected to form a hybrid network. For example, the wireline mode provides the timely delivery of time-sensitive information, while the physical transport provides huge volumes of content to be moved at very low cost. The service centers 29, 49, 69 and 89 will control the download of files from a central cache (cache located in the service centers) to either the wireline links or to an array of portable caches or storage. If download occurs over wireline links (or wireless links), the files are transferred directly to the cache or storage located within a designated kiosk 22, 24, 26 and 28. If, on the other hand, physical transport is required, the portable cache will be physically transported to the kiosks 22, 24, 26 and 28 on a scheduled route. At each location, the portable cache will be connected to the kiosk 22, 24, 26 and 28 and the files uploaded. Of course, a cache may include information for more than one kiosk 22, 24, 26 and 28, and more than one cache can be delivered to a kiosk 22, 24, 26 and 28. Caches, in one embodiment, can be left in the kiosk 22, 24, 26 and 28 or removed and returned to a service center 29, 49, 69 and 89 for reuse.

Continuing to refer to FIG. 1, a detailed description is provided. Network 10 is connected to regional networks 20, 40, 60 and 80 by a global hybrid network 50. Included within the global hybrid network 50 are global wireline connections 51 through 56, as well as a physical delivery route 86 traversed by a transport device 88 (such as a plane, train or automobile). The transport device 88 carries electronic storage devices 84, such as conventional disk drives based on storage technology. Included within the electronic storage devices 84 are various types of media content to which users have requested, or will request access, such as movies, televisions shows, news, periodical literature, novels and personal files. These files are downloadable to, for example, the electronic storage devices 84 from, for example, lines 81. In the preferred embodiment, lines 81 are fiber optic. However, one of ordinary skill will appreciate that any type of line capable of transferring data could be used. For example, instead of fiber optics, telephone lines or the Internet could be used to transfer data. The transport device 88 traverses the route 86, at a time conforming to user requests, to selectively deliver the devices 84 to service centers 29, 49, 69 and 89 which are located in regional networks 20, 40, 60 and 80, respectively. As shown, the physical delivery route 86 does not extend to the regional network 20, although, other physical delivery routes may connect to the regional network 20 to satisfy user demands. In the exemplary embodiment, the regional network 20 has a service center 29 connected to local transfer stations 22, 24, 26 and 28 by a local hybrid network 27. The service center 29 has electronic storage devices 25 and fiber optic lines 21, by which information is transferred for storage in the electronic storage devices 25. The local hybrid network 27 includes a physical delivery route 23 and a transport device 95. In the preferred embodiment, the transport device 95 travels the route 23 to deliver the electronic storage devices 25 selectively to the local transfer stations 22, 24 and 26. The local hybrid network 27 may also provide electronic transport of information between the service center 29 and the electronic storage devices 25. The local hybrid network 27 further includes regional wireline connections 91, 92, 93 and 94 linking the service center 29 to the local transfer stations 22, 24, 26 and 28, respectively. A service center 49 has wireline connections 72 and 74 to its local transfer stations 44 and 42, but differs structurally from the other service centers, for purposes of illustration, in that local transfer stations 42 and 44 are connected directly by link 71 to the Internet for smaller-sized, time-sensitive information such as stock quotes, news or email. Optionally, other elements of the network 10, such as the service centers, also connect directly to the Internet for content transfer.

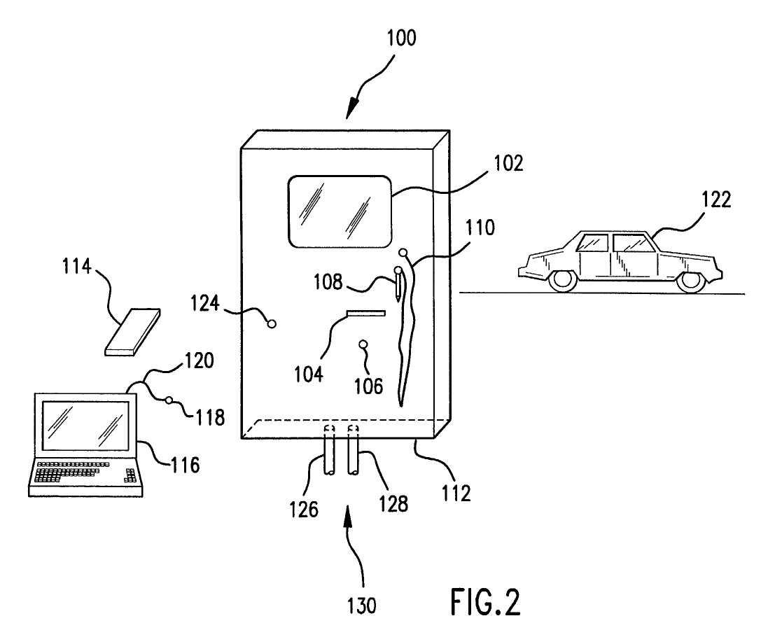

FIG. 2 illustrates an exemplary local transfer station 100. The local transfer station (or “kiosk”) 100, in this exemplary embodiment, comprises a viewing screen 102, such as a touch sensitive screen, and an input device 108, such as a light pen. In this exemplary embodiment, the input device 108 is connected via wire 110 to console 112. The console 112 supports one or more disk slots 104 for receiving a compact storage or terminal device 114, such as Personal Data Pack (“PDP”). A port 106 attached to the console 112 is designed to mate with a connector 118 attached by a wire 120 to a laptop computer 116. The console 112 also has a port 124 into which media content is downloadable from an electronic storage device delivered to the local transfer station 100. Extending from the bottom of the console 106 are input and output leads 126 and 128 that make up a regional wireline connection 130. It is readily understood that the local transfer station 100 depicted in FIG. 2 is merely illustrative in nature. A variety of stations and corresponding structures could be used to transfer information from the station 100 to a storage or terminal device 114. For example, the local transfer station 100 could be similar to an ATM or personal computer. Information can be downloaded, retrieved or uploaded from/to the local transfer station 100 to the storage or terminal device 114 via a wired connection, wireless connection or otherwise, a disk slot 104 is not necessarily required. Similarly, the ports 106 and 124 are not required to be wired connections. Any combination of drives, ports and/or links (wired or wireless) could be used to achieve the same results, as readily understood by the skilled artisan.

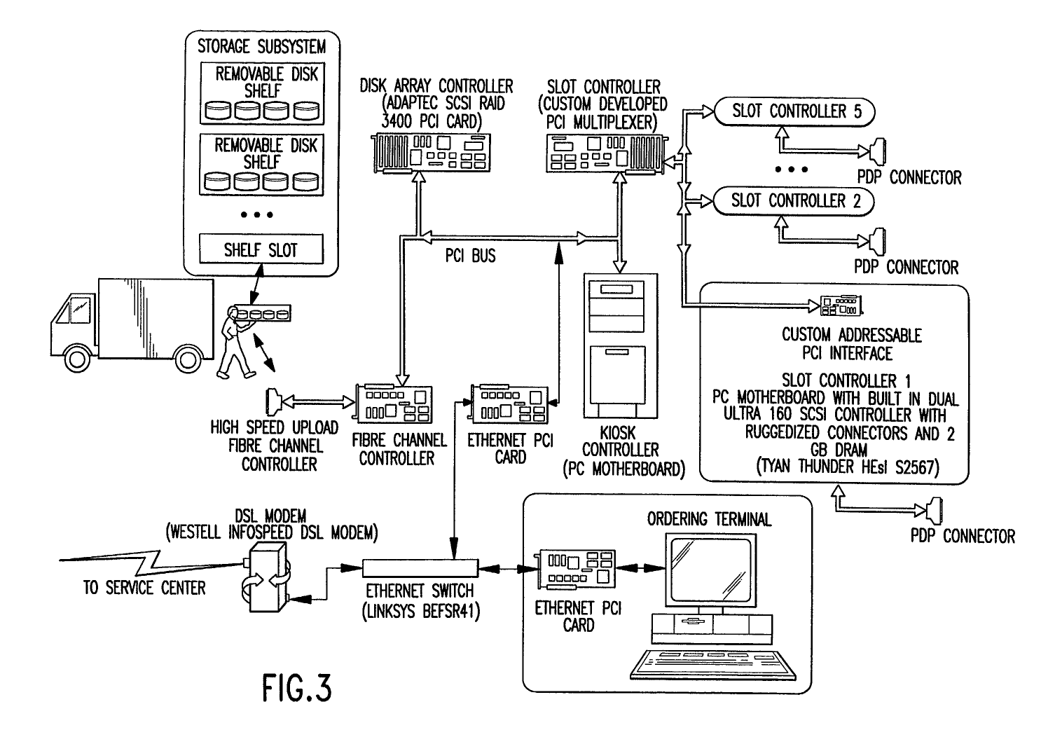

FIG. 3 is another exemplary embodiment of a local transfer station, or kiosk, in the invention. In this embodiment, customers can place, retrieve and review orders using the ordering terminal or through a terminal device. The information or content available at the kiosk is stored on a recordable medium, such as a hard drive. The information and content stored on the recordable medium are controlled by the disk controller. The kiosk communicates with the system through the “ports” connected to the serviceman (used to replace or update removable disks), high speed fiber (used to connect to service vehicles for download or upload of information, or via the network) and electronic control (such as through a telephone connection). The customer, on the other hand, communicates with the kiosk through the terminal device (or personal data pack “PDP”) connector ports or the ordering terminal (which may also be accomplished via, for example, the Internet). Other components in the kiosk, as illustrated in the FIG. 3, operate as readily understood by the skilled artisan.

FIG. 4 illustrates an exemplary terminal device, or PDP. In this exemplary embodiment, the PDP includes a hard disk (although any form of storage could be used), a high and low speed encryption/decryption device, an interface and PDP controller, an A/V interface and media controller and associated A/V connector (to enable connection between the PDP and an audio/visual device), SCSI connector (to enable connection between the PDP and a computer) and a KIOSK connector (to enable connection between the PDP and the kiosk). Also included is a processor (not illustrated) to control the device.

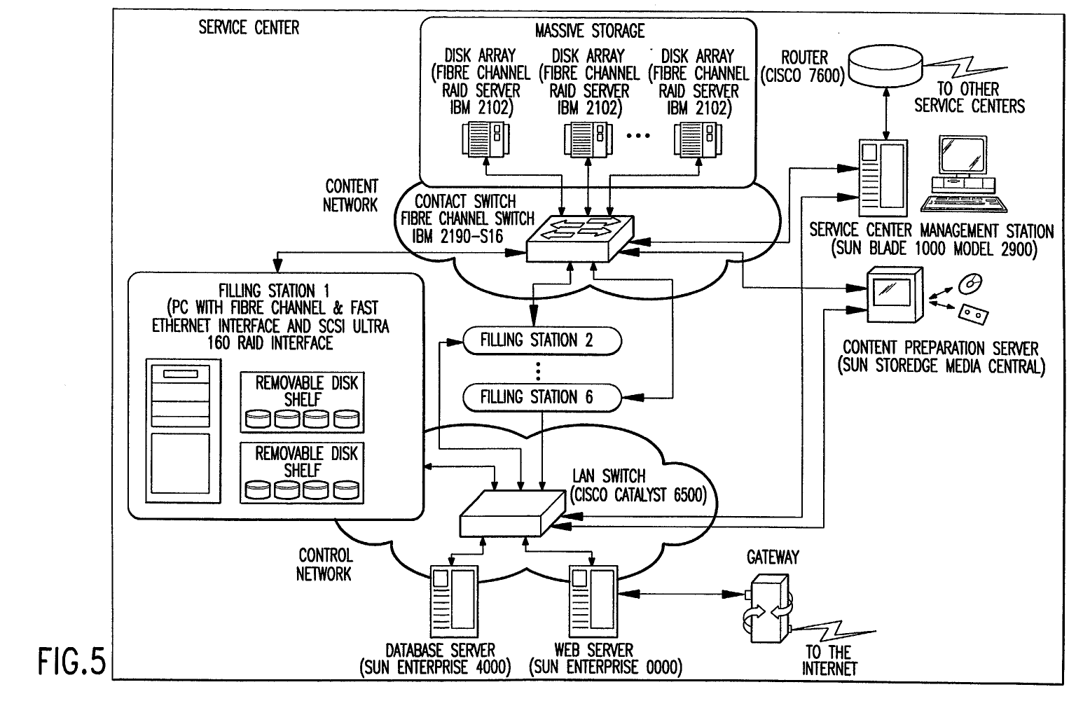

FIG. 5 illustrates an exemplary embodiment of a service center. In the exemplary service center, a router connects to a high speed fiber optic network line for direct connection to other service centers. A gateway connects to the Internet and is primarily used for control and order taking purposes. The filling stations 2-6 allow caches to be loaded with content for physical transport. Other components on the exemplary service center are readily understood by one having skill in the art.

### EXEMPLARY OPERATIONS USING THE NETWORK

In operation, referring to FIGS. 1 and 2, a user interacting with the local transfer station 100 uses the input device 108 to select a particular transfer station 22 to have selected media content (e.g., a movie) delivered and available at a desired time. The service center 29 is linked to the selected transfer station 22, and receiving requests from other users in that regional network 20, schedules routes traversing selected local transfer stations at corresponding times. Orders need not be placed at a transfer station, but could be placed, for example, over the Internet. When the user arrives at the selected transfer station 22, the ordered media content is available for download since it has already been transferred to the station 22. The user connects his or her PDP 114 or portable device 116 to the local transfer station 100 to download the selected and ordered media content. The download can be triggered from a signal from the PDP 114 or portable device 116. Alternatively, for example, the download can be wireless to a user in a nearby vehicle 122, as by infrared (IR) transmission. Upon download, the media content is available for convenient playback at the user's command, as previously described.

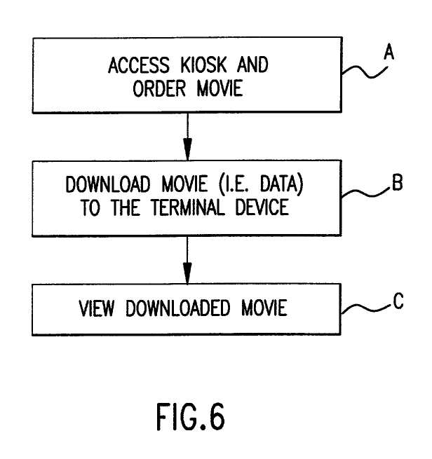

In one exemplary use of the system, a user can order movies from the kiosks in a manner similar to renting a movie from a store. Referring to FIG. 6, a customer (i.e. user) accesses the kiosk and orders a movie at A. The movie, which is already stored at the kiosk (or another kiosk nearby), is download by the customer onto a terminal device at B. The customer then returns home, and views the movie downloaded to the terminal device at C. In one embodiment, the terminal device connects directly to the television or other display device, or includes a display of its own. In another embodiment, the terminal device is “plugged” into another device, such as a VCR or DVD player for viewing.

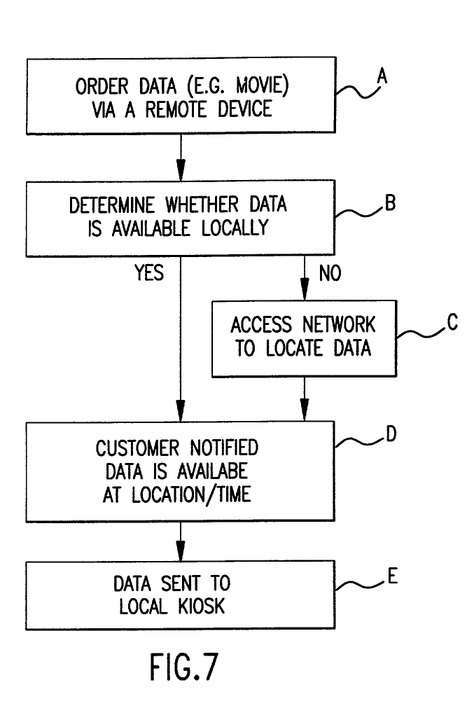

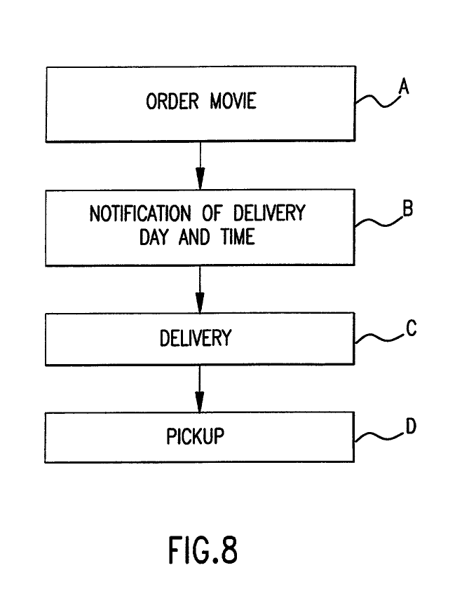

In another exemplary use of the system, a user places an order for information (such as a movie) using a device physically removed from the kiosk, for example, using a PDA, the Internet or a telephone. Referring to FIG. 7, the customer orders a movie via a PDA, the Internet or a telephone at A. The system checks to see whether the ordered movie is located at a nearby kiosk. In this example, the system determines that the movie is not readily available (i.e. not presently stored) at the kiosk at B. The system then determines whether the movie is available at a local service center at C. If available, the movie is downloaded to the local kiosk, as described above. If the movie is not available at the local service center, then other service centers accessible on the network are checked for availability. Once the movie is located, it is downloaded (either through the local service center, or directly to the local kiosk) from the service center. The customer is then notified when and where the movie will be available for download at D. The movie is transferred to the various local service centers and kiosks for pick up by the customer at E. The portion of the system making the various determination depends on the task being performed, the location of the task, etc. For example, in once instance, the local service center may provide the determination, while in another instance it may be the kiosk that makes the determination. In still another exemplary use of the system, a customer orders a movie that must be delivered from a global distance, for example delivery from India to the United States, as illustrated in FIG. 8. In this example, the customer first orders the movie at A. The customer is then notified of the time and place for picking up the movie at B. The movie is delivered from India, using for example FedEx or fiber link, to a regional service center at C. The movie is then delivered to the local kiosk for customer pickup at D, in a manner similar to that described above.

Each of the above described examples may also be implemented in reverse. That is, information can be uploaded from the local kiosk and delivered to the service center for proper delivery to a remote (i.e. another) kiosk. In this way, a movie could be delivered to a kiosk in another country. A profile of the user can be stored over time and made available to personalize information.

While a preferred embodiment has been shown and described, it should be understood that a number of changes and modifications are possible therein. Accordingly it is to be understood that there is no intention to limit the invention to the precise construction disclosed herein, and the right is reserved to all changes and modifications coming within the scope of the invention as defined in the appended claims.

What is claimed is:

1. A method for distributing data over a network, comprising:
providing local transfer stations configured to receive the data from a remote storage device and to output the data to a terminal device comprising a recordable medium for storing the data and information for data authorization; and
transferring the data to at least one of the local transfer stations for download of the data to the terminal device.

2. The method of claim 1, wherein the data is stored in an encrypted format based at least in part on the information for data authorization.

3. The method of claim 1, wherein the transferring occurs via a communicative coupling between the remote storage device and the local transfer stations.

4. The method of claim 2, wherein the communicative coupling comprises at least one of a network connection, a wireless link, a terrestrial broadcast, a satellite broadcast, fiber optic link or physical transport.

5. The method of claim 1, further comprising receiving a request for the data, wherein the transferring provides the storage device to at least one of the local transfer stations according to the request.

6. The method of claim 5 wherein the request specifies a particular time before which the transferring is to be performed.

7. The method of claim 1, further comprising receiving a plurality of requests for delivery of the data to selected local transfer stations, wherein the transferring includes scheduling the delivery to the selected transfer stations.

8. The method of claim 1, further comprising transferring the data from a remote site via electronic connection to one or more of the local transfer stations.

9. The method of claim 1, further comprising operating at least one of the local transfer stations to download a requested portion of the data to the receiving device.

10. The method of claim 9, wherein the download for the local transfer station to the device is wireless.

11. The method of claim 9, further comprising outputting the data in response to a signal from the receiving device.

12. The method of claim 5, wherein the request selects the data and at least one of said local transfer stations.

13. The method of claim 1, further comprising providing a service center coupled to at least one of the local transfer stations by communication lines.

14. The method of claim 13, wherein at least one of the local transfer stations are located at commuter transit stations and wherein the data includes movies.

15. A method of accessing data for download to a receiving device, comprising:
providing a plurality of service centers to process requested data from users on a network;
providing a plurality of local transfer stations within a geographic area and accessible by the network, the local transfer stations configured with links to link with the receiving device in order to select and download the requested data over one of the links; and
loading the plurality of transfer stations with subsets of the data in the geographic area.

16. A system for data distribution, the data stored on a recordable medium, comprising:
local transfer stations configured to receive the data from the recordable medium and to output the data;
a service center to process requests for the data at at least one of the local transfer stations, the processing including scheduling the delivery of the requested data to the selected transfer station; and
transport devices for physically transporting the recordable medium storing the requested data to the selected transfer station.

17. The system of claim 16, wherein the local transfer stations output the data to a receiving device.

18. The system of claim 16, further comprising a communications link between at least one of the local transfer stations and the service center, wherein the service center receives the requests from the at least one local transfer station via the link.

19. The system of claim 18, further comprising at least another service center for servicing the local transfer stations and communication links between the service center and the at least another service center.

20. A method for distribution of data over a network, comprising:
transporting data from a service center to a local transfer station, wherein the data is requested by a user having access to the network;
storing the requested data at the local transfer station for retrieval by the user; and
transferring the requested data to a portable receiving device, wherein the data stored on the portable receiving device is encrypted and configured to decrypt the requested data.

21. The method of claim 20, wherein the encrypted data is personalized for each user.

22. A method of transferring data over a hybrid network, the hybrid network including a plurality of networks, each network configured for physical and/or electronic transfer of the data, comprising:
physically transporting data from a first network to a second network;
storing the transported data to a local transfer station for distribution based on a user request; and
transferring the requested data to a portable receiving device, wherein the data stored on the local transfer station is encrypted and the portable receiving device is configured to decrypt the data.
